(19) United States
(12) Patent Application Publication
(10) Pub. No.: US 2026/0215582 A1
(43) Pub. Date: Jul. 30, 2026

(54) MULTIPURPOSE STAND FOR PET

(71) Applicant: Timotion Korea Co., Ltd, Gyeonggi-do (KR)

(72) Inventor: Hyunjeong CHANG, Gyeonggi-do (KR)

(21) Appl. No.: 19/404,873

(22) Filed: Dec. 1, 2025

(30) Foreign Application Priority Data
Jan. 24, 2025 (KR) 10-2025-0010770

(51) Int. Cl. A47B 85/06; A47B 3/00; A01K 13/00

(52) U.S. Cl. CPC A47B 85/06; A47B 3/002; A01K 13/001

(57) ABSTRACT

A multipurpose stand for pets, includes: a first base frame including a pair of first support frames arranged parallel to each other, and a first connection frame connecting one end of the pair of first support frames; a second base frame including a pair of second support frames arranged parallel to each other and rotatably coupled to the pair of first support frames, and a second connection frame connecting one end of the pair of second support frames. A fixing frame connects between the first support frame and the second support frame, and supports the first support frame and the second support frame to be disposed at a predetermined angle. A cradle frame rotatably coupled to the pair of first support frames, supporting a bottom surface of an object on the first connection frame and the second connection frame, and having a changeable supporting position corresponding to the object height.

This application claims priority under 35 U.S.C. §119(a) to Korean Application Serial No. 10-2025-0010770, which was filed in the Korean Intellectual Property Office on January 24, 2025, the entire content of which is incorporated herein by reference.

### BACKGROUND OF THE INVENTION

### 1. Field of the Disclosure

The present invention relates to a multipurpose stand for pets.

### 2.Description of the Related Art

Generally, pets were kept separately from users in spatially separated areas. However, as residential environments have shifted to focus on apartment buildings and villas, and as pets have begun to be recognized not merely as animals but as subjects of emotional connection, the number of cases where pets are kept indoors has recently been increasing.

When keeping pets indoors, it is essential to regularly bathe pets for indoor hygiene management and pet health management. However, when bathing pets in a home bathroom, there is a problem of causing significant inconvenience to the user as the user must maintain a posture with the waist or knees bent for a long time.

### SUMMARY OF THE INVENTION

The present invention was devised to solve the above problems, and aims to provide a multipurpose stand for pets that can support a pet bathtub or grooming table, etc.

A multipurpose stand for pets comprising: a first base frame including a pair of first support frames disposed parallel to each other and a first connection frame connecting one end of the pair of first support frames; a second base frame including a pair of second support frames disposed parallel to each other and rotatably coupled to the pair of first support frames, and a second connection frame connecting one end of the pair of second support frames; a fixing frame connecting between the first support frame and the second support frame and supporting the first support frame and the second support frame to be disposed at a predetermined angle; and a cradle frame rotatably coupled to the pair of first support frames, supporting a bottom surface of an object disposed on the first connection frame and the second connection frame, and having a supporting position that changes corresponding to the height of the object.

In the multipurpose stand for pets as described above, the cradle frame can include: a pair of first cradle members rotatably coupled to the pair of first support frames; a second cradle member connecting one end of the pair of first cradle members and bent in a direction perpendicular to the pair of first cradle members; and a locking frame connecting the other end of the pair of first cradle members.

In the multipurpose stand for pets as described above, the cradle frame can be configured such that the pair of first cradle members rotate in a first direction so that the second cradle member is disposed horizontally and the second cradle member supports the bottom surface of a first object. The pair of first cradle members rotate in a second direction opposite to the first direction so that the pair of first cradle members are disposed horizontally and support the bottom surface of a second object having a height higher than the first object.

In the multipurpose stand for pets as described above, the first base frame can include: a stopper frame connecting between the pair of first support frames; a stopper plate coupled to the stopper frame; and a stopper slidably coupled to the stopper plate and restraining the locking frame from rotating in the second direction when the second cradle member is in a horizontal state.

In the multipurpose stand for pets as described above, the pair of first support frames can include bent portions bent inward in a direction facing each other. When the pair of first cradle members are horizontal, the second cradle member is supported on the bent portions and restrained from further rotating in the second direction.

In the multipurpose stand for pets as described above, the fixing frame can include: a first link rotatably coupled to the first support frame; and a second link rotatably coupled to the second support frame and the first link.

The multipurpose stand for pets described above can also include: a pair of first length extension parts inserted into the other end of the pair of first support frames, respectively, to adjust length; and a pair of second length extension parts inserted into the other end of the pair of second support frames, respectively, to adjust length.

According to the multipurpose stand for pets according to the present invention, it is possible to support a pet bathtub or grooming table, etc., so that the user can perform bathing or grooming while standing. In addition, the height supported by the cradle frame can be changed according to the purpose of the object being supported, so that it can be applied to various purposes. When not in use, the base frame can be folded and stored, thereby improving space utilization. Furthermore, the height of the base frame can be adjusted corresponding to the user's height, thereby improving convenience of use.

### BRIEF DESCRIPTION OF THE DRAWINGS

FIG. 1 is a perspective view schematically illustrating a multipurpose stand for pets according to an embodiment of the present invention.

FIG. 2 is a side view schematically illustrating a multipurpose stand for pets according to an embodiment of the present invention.

FIG. 3 is a front view schematically illustrating a multipurpose stand for pets according to an embodiment of the present invention.

FIG. 4 is a side view schematically illustrating a state in which the second cradle member supports a first object in a multipurpose stand for pets according to an embodiment of the present invention.

FIG. 5 is a perspective view schematically illustrating a state in which the first cradle member is disposed to support an object in a multipurpose stand for pets according to an embodiment of the present invention.

FIG. 6 is a side view schematically illustrating a state in which the first cradle member is disposed to support an object in a multipurpose stand for pets according to an embodiment of the present invention.

FIG. 7 is a front view schematically illustrating a state in which the first cradle member is disposed to support an object in a multipurpose stand for pets according to an embodiment of the present invention.

FIG. 8 is a side view schematically illustrating a state in which the first cradle member supports a second object in a multipurpose stand for pets according to an embodiment of the present invention.

FIG. 9 is a side view schematically illustrating a state in which the first base frame and the second base frame are folded in a multipurpose stand for pets according to an embodiment of the present invention.

FIG. 10 is a perspective view schematically illustrating a state in which the length of the length extension part is extended in a multipurpose stand for pets according to an embodiment of the present invention.

### DETAILED DESCRIPTION OF THE INVENTION

Hereinafter, preferred embodiments of the present invention will be described in detail with reference to the accompanying drawings.

The present invention may be subject to various modifications and may have various embodiments, and specific embodiments are illustrated in the drawings and will be specifically described in the detailed description. However, this is not intended to limit the present invention to specific embodiments, and should be construed as including all modifications, equivalents, and substitutes included in the spirit and technical scope of the present invention.

The terminology used in the present application is used only to describe specific embodiments and is not intended to limit the present invention. Singular expressions may include plural expressions unless the context clearly indicates otherwise.

Unless defined otherwise, all terms used herein, including technical or scientific terms, may have the same meaning as commonly understood by one of ordinary skill in the art to which the present invention belongs. Terms as defined in commonly used dictionaries may be interpreted as having a meaning consistent with the meaning in the context of the related art, and may not be interpreted in an ideal or overly formal sense unless clearly defined in the present application.

Hereinafter, specific embodiments of the present invention will be described with reference to the accompanying drawings.

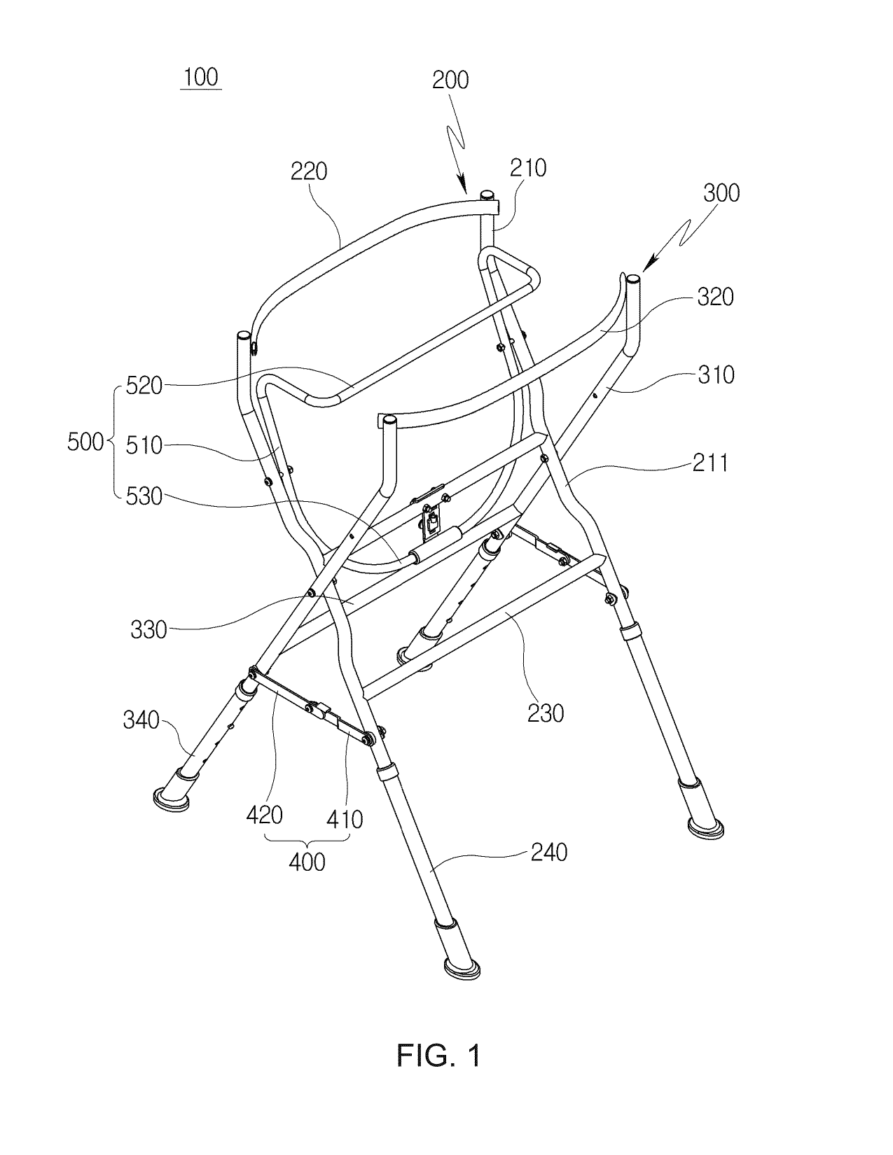

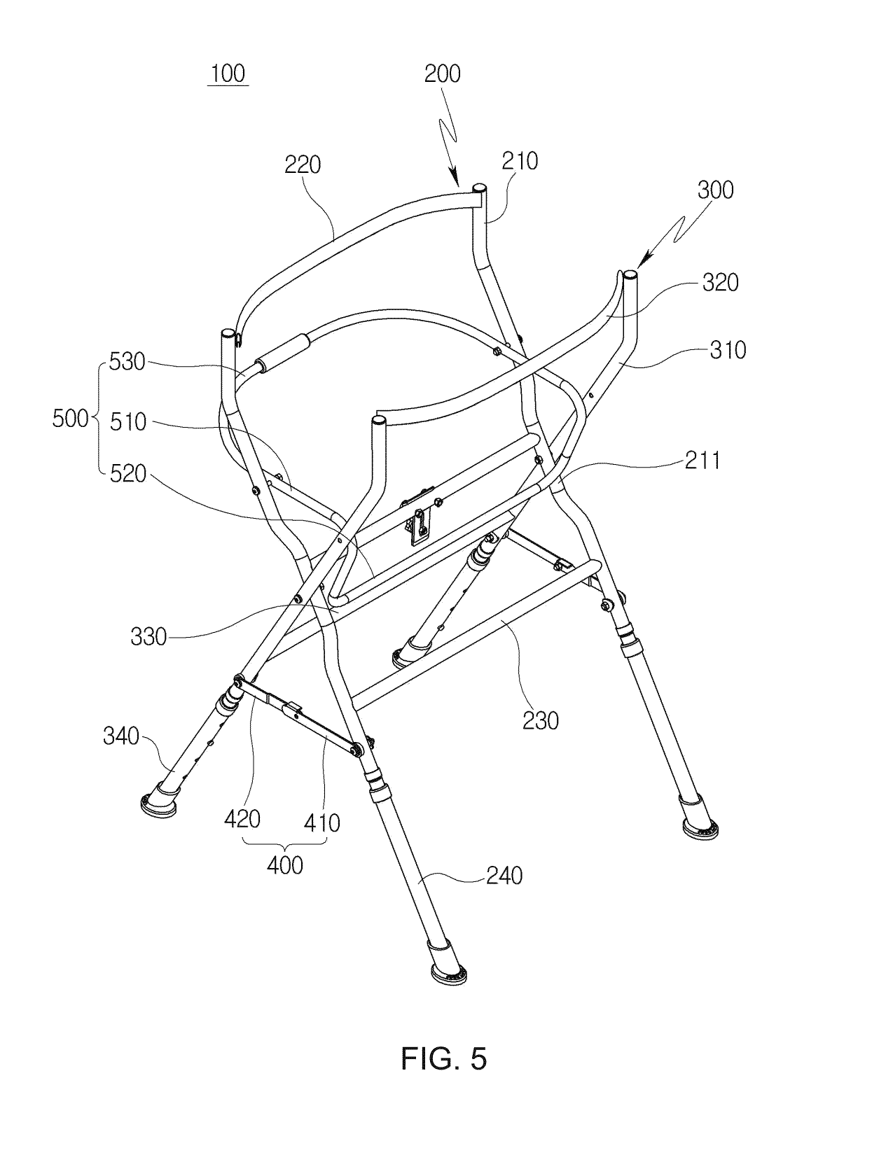

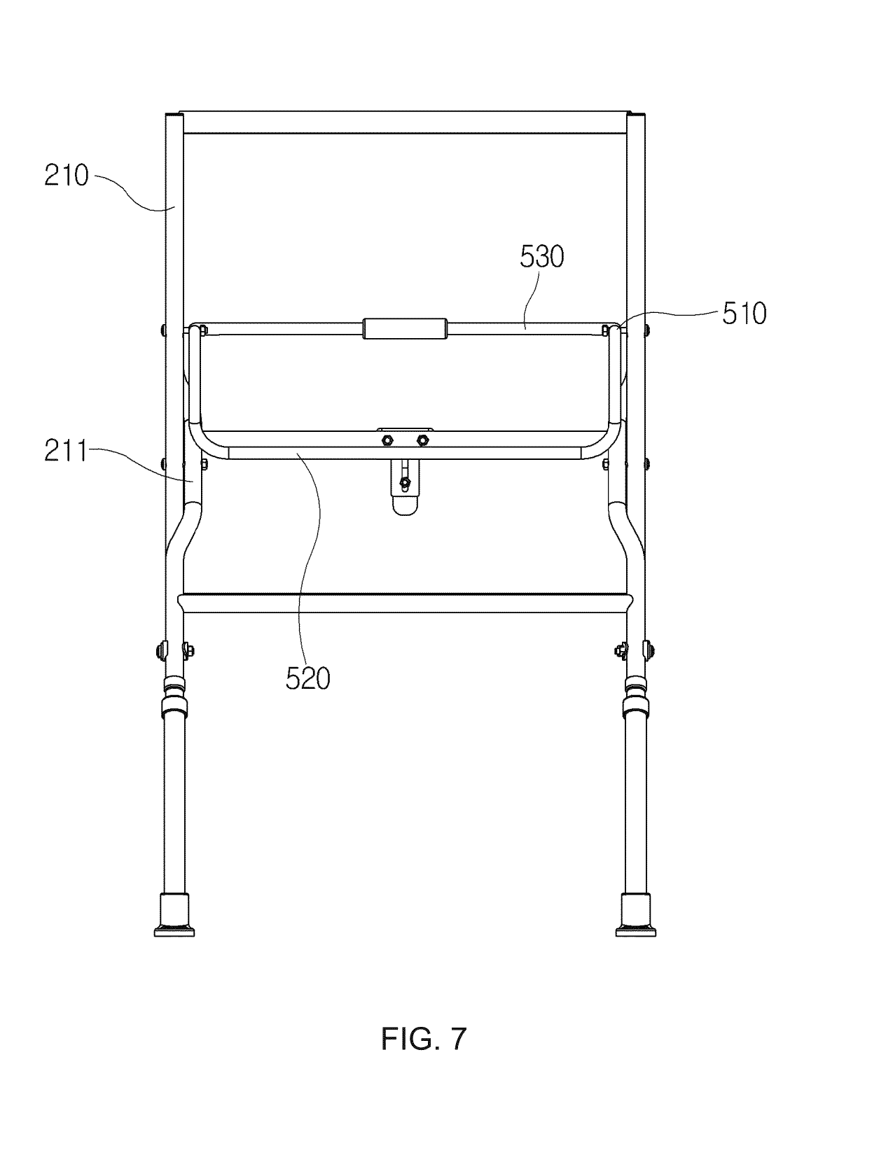

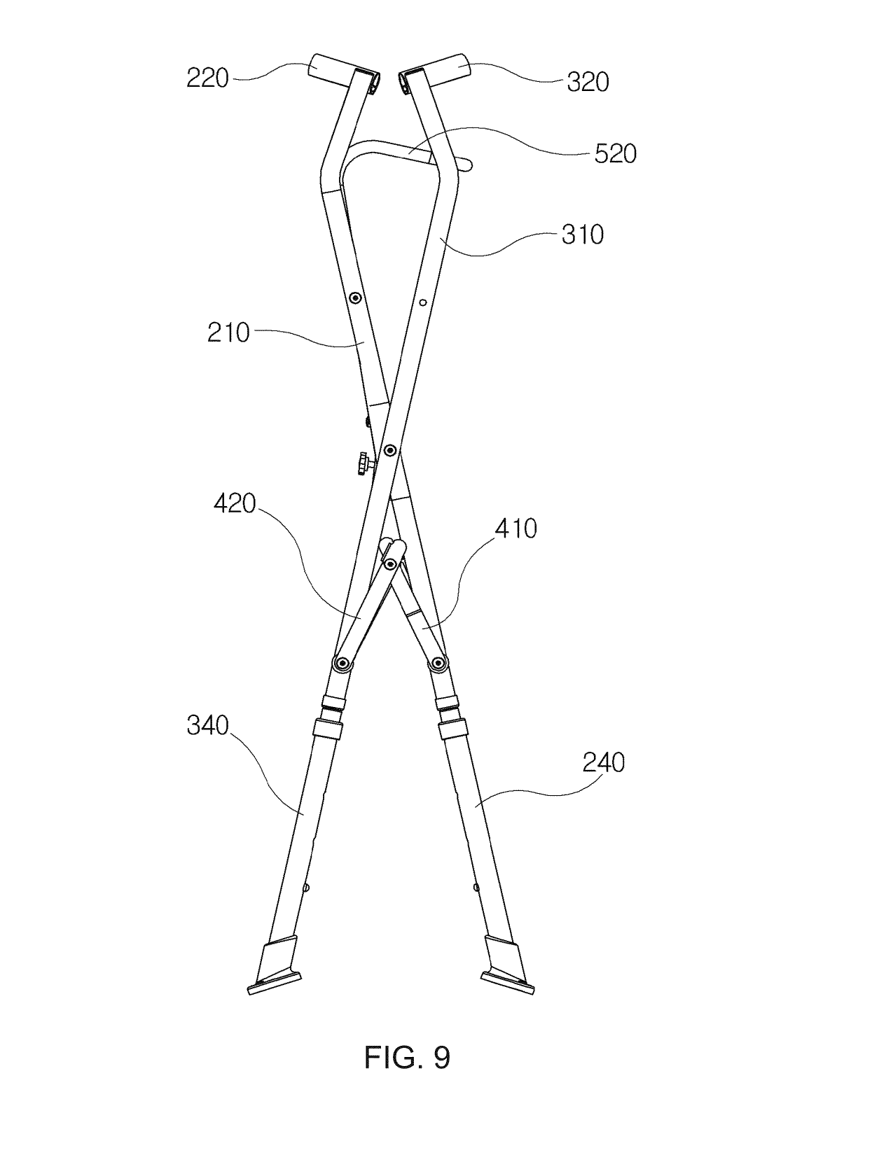

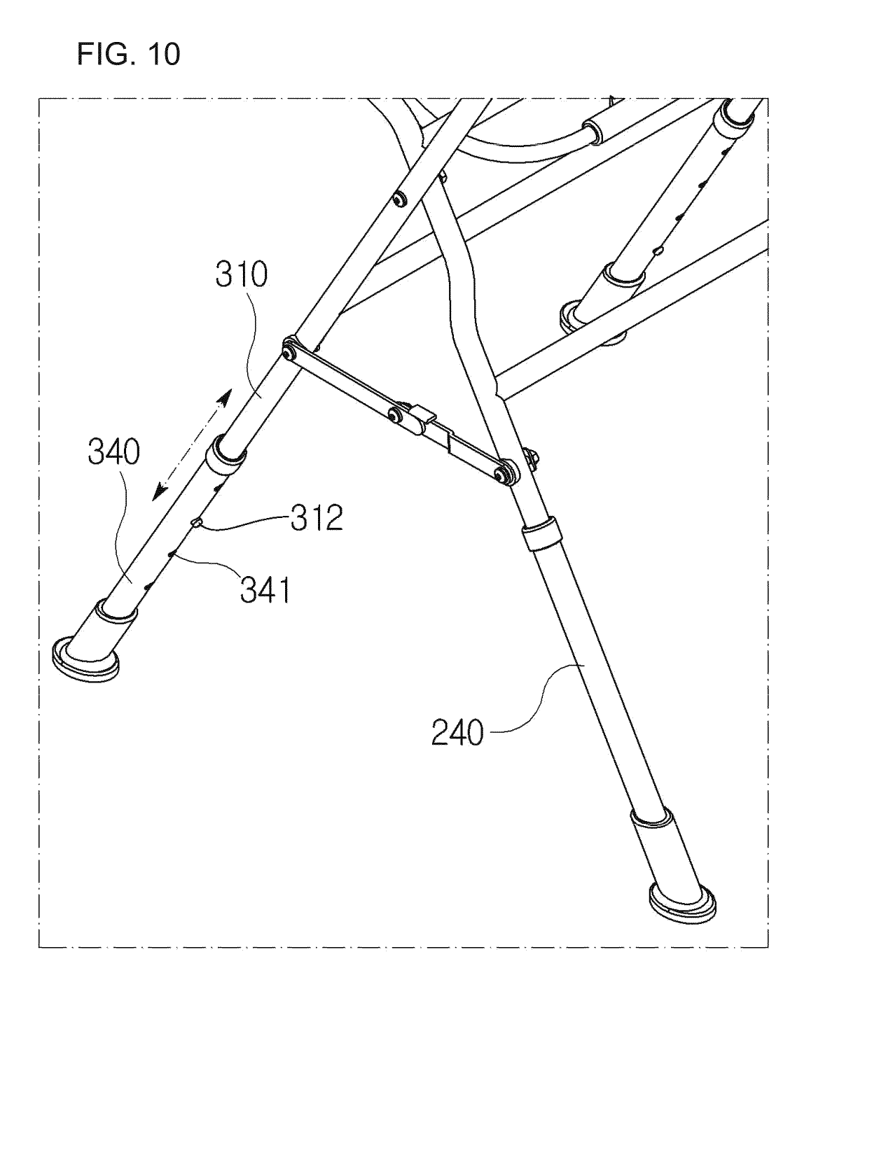

FIGS. 1 to 4 are views schematically illustrating a state in which a second cradle member is disposed to support an object in a multipurpose stand for pets according to an embodiment of the present invention, and FIGS. 5 to 8 are views schematically illustrating a state in which a first cradle member is disposed to support an object in the multipurpose stand for pets. FIG. 9 is a side view schematically illustrating a state in which a first base frame and a second base frame are overlapped in the multipurpose stand for pets, and FIG. 10 is a perspective view schematically illustrating a state in which the length of a length extension part is extended in the multipurpose stand for pets.

Referring to FIGS. 1 to 10, a multipurpose stand (100) for pets according to an embodiment of the present invention may include a first base frame (200), a second base frame (300) rotatably coupled to the first base frame (200), a fixing frame (400) supporting the first base frame (200) and the second base frame (300) to be disposed at a predetermined angle, and a cradle frame (500) rotatably coupled to the first base frame (200) and supporting an object.

The first base frame (200) may include a pair of first support frames (210) disposed parallel to each other and a first connection frame (220) connecting one end of the pair of first support frames (210).

That is, the first base frame (200) may be formed in an overall C-shape. In addition, it may further include a first spacing maintaining part (230) connecting between the pair of first support frames (210) and maintaining the spacing between the pair of first support frames (210).

In addition, it may further include bent portions (211) bent inward in a direction facing each other in a central region of the pair of first support frames (210). The bent portions (211) are formed on each of the pair of first support frames (210), and the second base frame (300) may be rotatably coupled to the outside of the bent portions (211).

The second base frame (300) may include a pair of second support frames (310) disposed parallel to each other and rotatably coupled to the pair of first support frames (210), and a second connection frame (320) connecting one end of the pair of second support frames (310).

That is, the second base frame (300) may be formed in an overall C-shape. In addition, it may further include a second spacing maintaining part (330) connecting between the pair of second support frames (310) and maintaining the spacing between the pair of second support frames (310).

In addition, the pair of second support frames (310) may be rotatably coupled to the outside of the bent portions (211) formed on the pair of first support frames (210), respectively. Therefore, the pair of first support frames (210) and the pair of second support frames (310) may be disposed to face each other in regions other than the region where the bent portions (211) are formed.

The fixing frame (400) may be configured to connect between the first support frame (210) and the second support frame (310) and support the first support frame (210) and the second support frame (310) to be disposed at a predetermined angle.

More specifically, the fixing frame (400) may include a first link (410) rotatably coupled to the first support frame (210) and a second link (420) rotatably coupled to the second support frame (310) and the first link (410).

Therefore, as shown in FIG. 9, when the first support frame (210) and the second support frame (310) rotate to overlap in a direction facing each other, the first link (410) and the second link (420) may also be disposed to overlap while rotating relative to each other. That is, when the multipurpose stand (100) is not in use, it can be stored in a reduced size in this overlapped state.

In addition, when the first support frame (210) and the second support frame (310) rotate in a direction away from each other, the first link (410) and the second link (420) are disposed in a linear form, thereby supporting the first support frame (210) and the second support frame (310) to maintain a state disposed at a predetermined angle. In this state, an object can be disposed on the first connection frame (220) and the second connection frame (320) and used for the intended purpose.

The fixing frame (400) may be provided as a pair and configured to connect each of the pair of first support frames (210) and the pair of second support frames (310).

The cradle frame (500) may be rotatably coupled to the pair of first support frames (210), support the bottom surface of an object disposed on the first connection frame (220) and the second connection frame (320), and be configured such that the supporting position changes corresponding to the height of the object.

More specifically, the cradle frame (500) may include a pair of first cradle members (510) rotatably coupled to the pair of first support frames (210), a second cradle member (520) connecting one end of the pair of first cradle members and bent in a direction perpendicular to the pair of first cradle members (510), and a locking frame (530) connecting the other end of the pair of first cradle members (510).

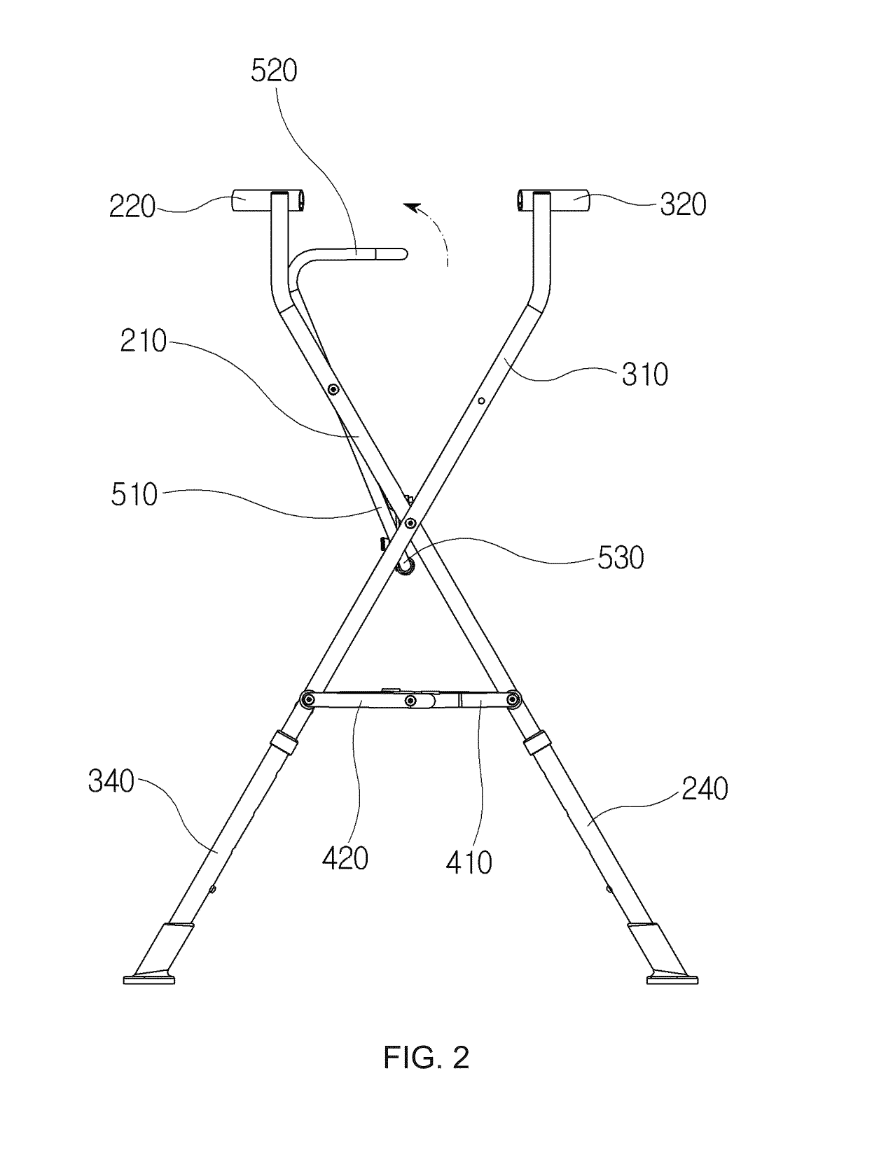

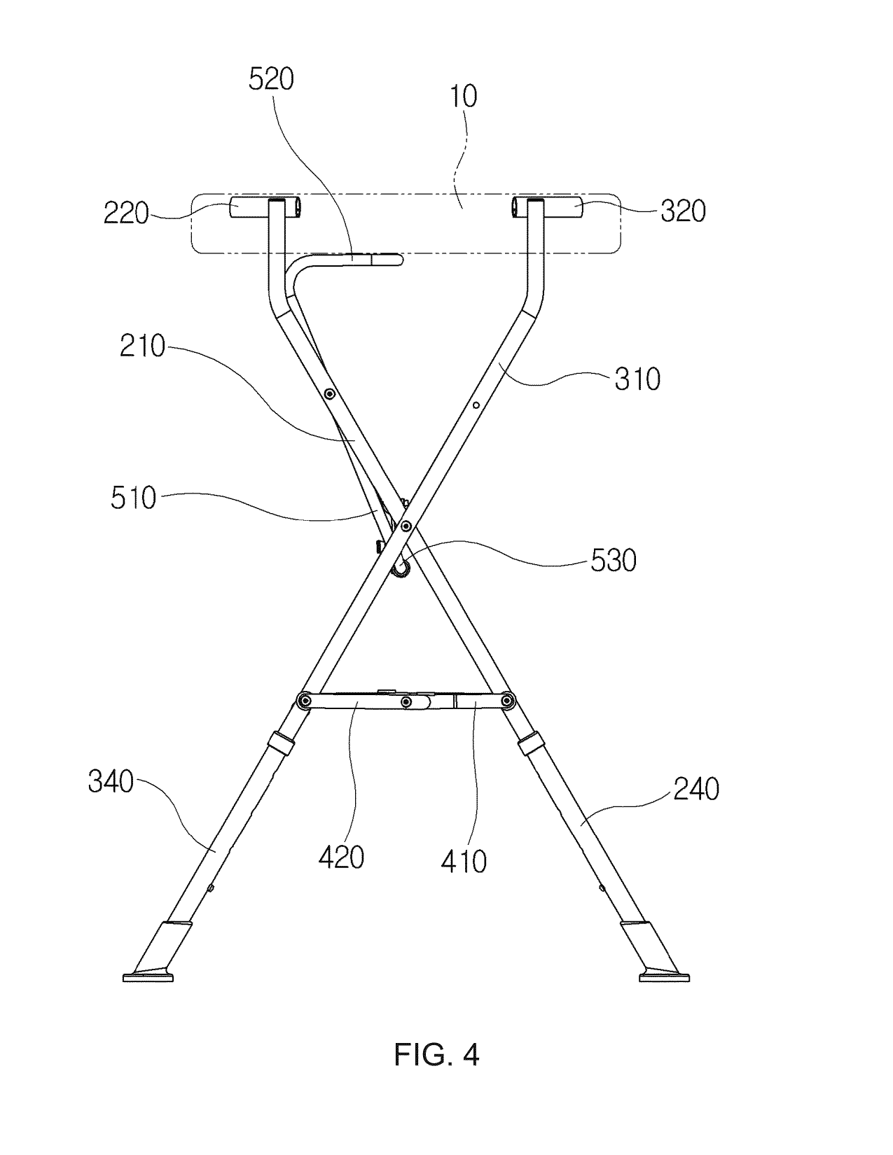

With this configuration, the cradle frame (500) is configured such that the pair of first cradle members (510) rotate in a first direction (counterclockwise in FIG. 2) so that the second cradle member (520) is disposed horizontally with respect to the ground, and as shown in FIG. 4, the second cradle member (520) can support the bottom surface of a first object (10).

To maintain the state in which the second cradle member (520) is disposed horizontally, it may further include a stopper (253) that locks and supports the locking frame (530).

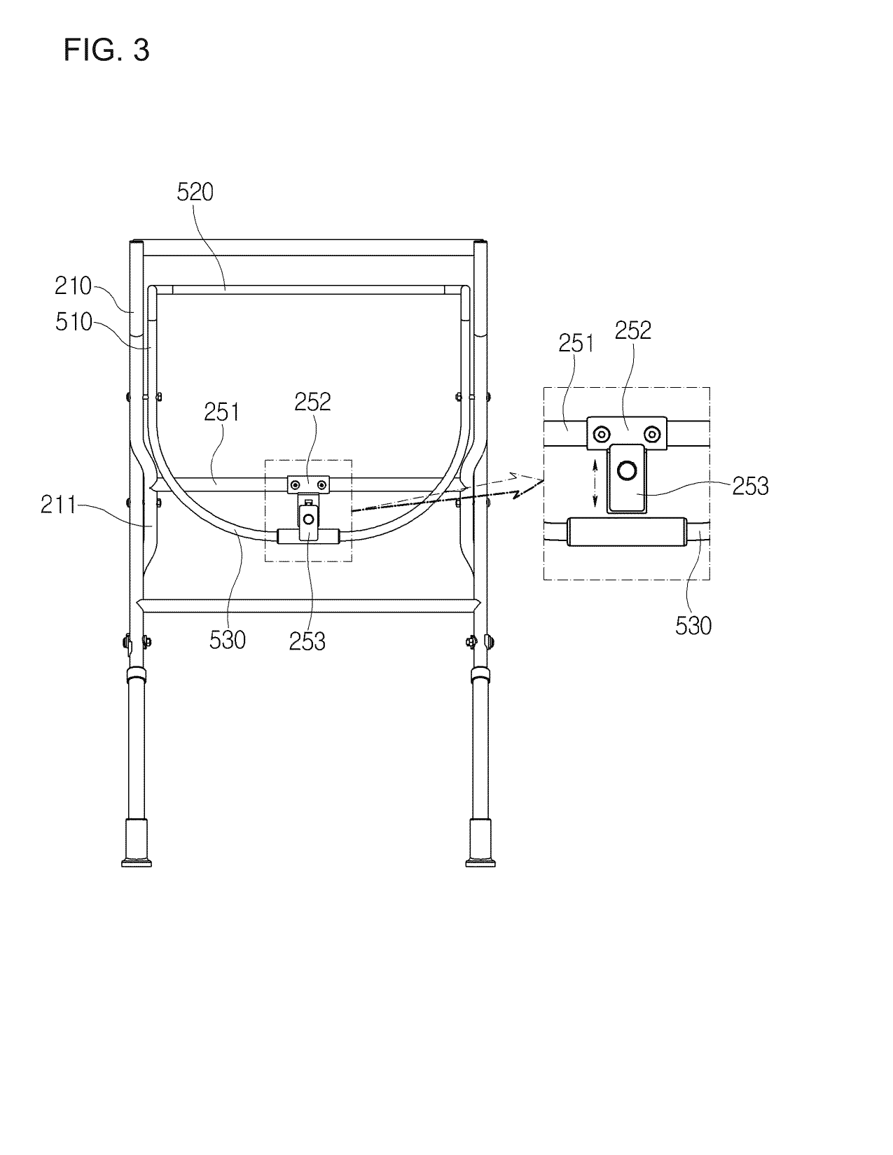

More specifically, referring to FIG. 3, the first base frame (200) may include a stopper frame (251) connecting between the pair of first support frames (210), a stopper plate (252) coupled to the stopper frame (251), and the stopper (253) slidably coupled to the stopper plate (252) and selectively restraining the locking frame (530).

The stopper (253), when moved downward from the stopper plate (252) and protruding outward, can restrain the locking frame (530) from rotating in a second direction opposite to the first direction when the second cradle member (520) is horizontal. In addition, when the stopper (253) moves upward from the stopper plate (252), it releases the restraint of the locking frame (530), allowing the locking frame (530) to rotate.

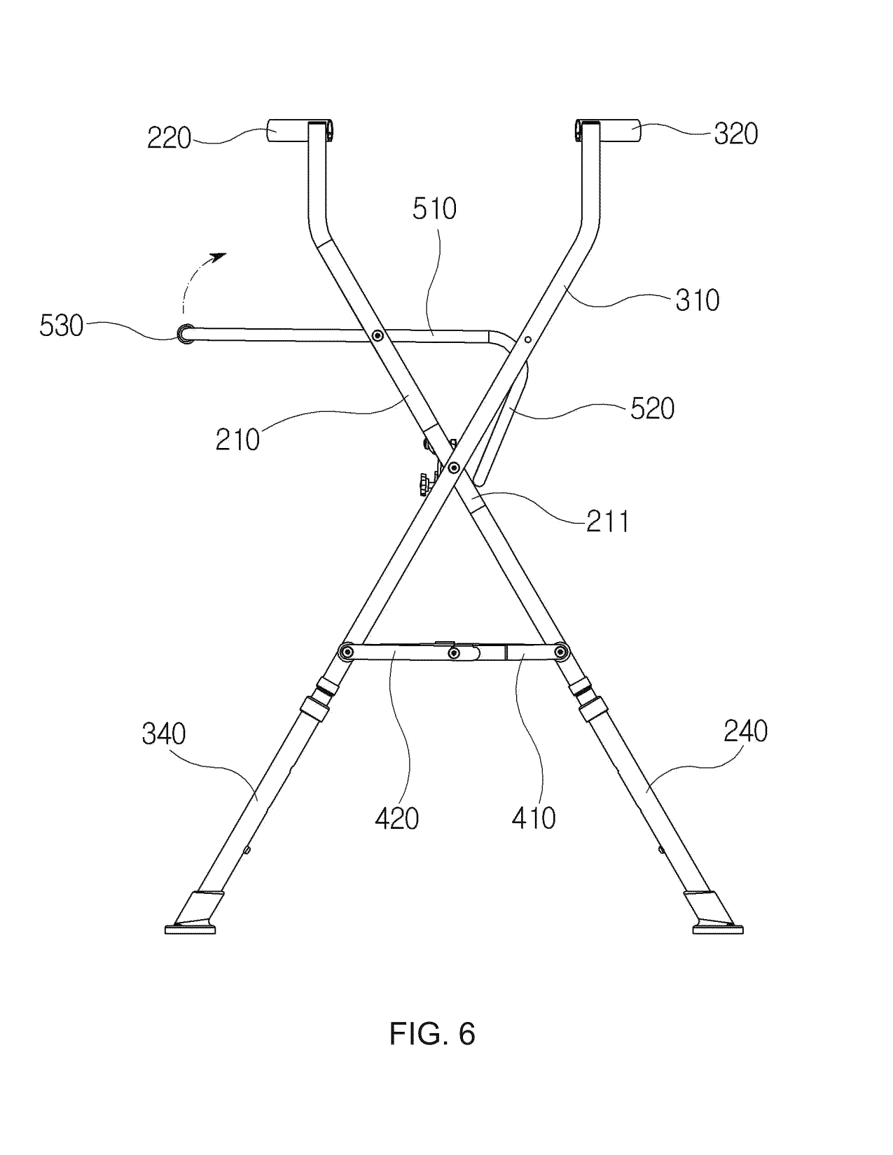

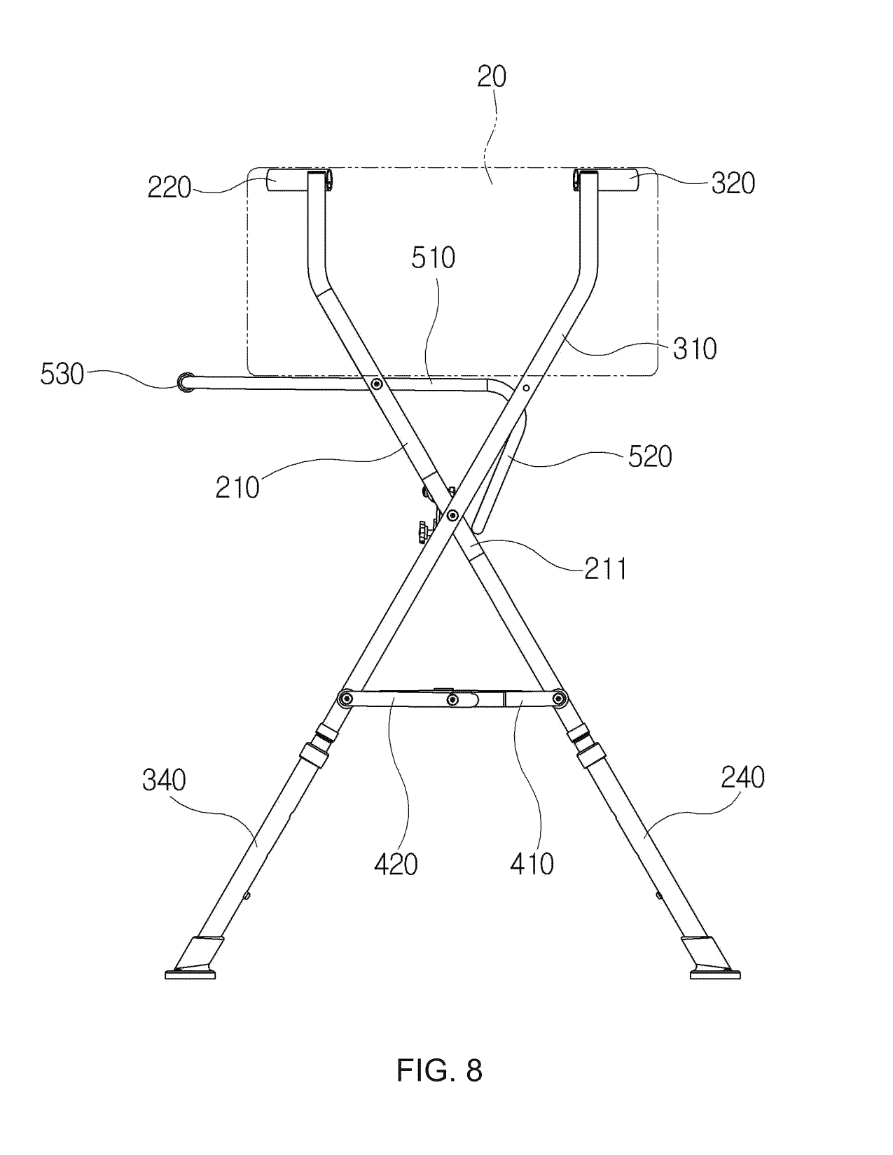

In addition, the cradle frame (500) is configured such that the pair of first cradle members (510) rotate in the second direction (clockwise in FIG. 6) so that the pair of first cradle members (510) are disposed horizontally with respect to the ground, and as shown in FIG. 8, can support the bottom surface of a second object (20) having a height higher than the first object (10).

At this time, as shown in FIG. 6, when the pair of first cradle members (510) are horizontal, the second cradle member (520) is supported on the bent portions (211) formed on the pair of first support frames (210) and can be restrained from further rotating in the second direction.

With this configuration, as shown in FIG. 4, when the cradle frame (500) rotates so that the second cradle member (520) is disposed horizontally, it can support the first object (10) having a relatively low height. For example, the first object (10) may be configured as a table, etc.

Therefore, the first object (10), which is a table, is supported by the second cradle member (520), the first connection frame (220), and the second connection frame (320), and a pet can be positioned on the table so that the user can perform tasks such as cutting fur or using a dryer while standing.

Alternatively, as shown in FIG. 6, when the cradle frame (500) rotates so that the first cradle member (510) is disposed horizontally, it can support the second object (20) having a relatively high height. For example, the second object (20) may be configured as a bathtub, etc.

Therefore, the second object (20), which is a bathtub, is supported by the first cradle member (510), the first connection frame (220), and the second connection frame (320), and a pet can be positioned in the bathtub so that the user can perform bathing while standing.

In addition, to adjust the height of the multipurpose stand (100) corresponding to the user's height, it may further include a pair of first length extension parts (240) inserted into the other end of the pair of first support frames (210), respectively, to adjust length, and a pair of second length extension parts (340) inserted into the other end of the pair of second support frames (310), respectively, to adjust length.

In one embodiment, referring to FIG. 10, the second length extension part (340) has a plurality of through holes (341) formed at predetermined intervals along the longitudinal direction, and the second support frame (310) may have a locking protrusion (312) inserted into the through hole (341).

In addition, the locking protrusion (312) may be elastically coupled to the second length extension part (340) so that when external force is applied, the locking protrusion (312) is inserted toward the inside of the second length extension part (340), and when the external force is removed, it is configured to protrude toward the outside of the second length extension part (340). The first length extension part (240) may also be configured and operated in the same manner as the second length extension part (340).

With this configuration, the locking protrusion (312) is positioned to be inserted into any one of the plurality of through holes (341) formed in the longitudinal direction of the second length extension part (340), thereby adjusting the length at which the second length extension part (340) is withdrawn from the second support frame (310) to adjust the height of the multipurpose stand (100). Of course, the configuration for adjusting the height of the multipurpose stand (100) is not limited thereto, and various known methods may be applied.

Although the present invention has been described in detail through specific embodiments above, this is for the purpose of specifically explaining the present invention, and the present invention is not limited thereto. It is obvious that the present invention can be modified or improved by those skilled in the art within the technical spirit of the present invention.

Simple modifications or changes to the present invention all belong to the scope of the present invention, and the specific scope of protection of the present invention will be clarified by the appended claims.

100: Multipurpose stand for pets

200: First base frame

210: Pair of first support frames

211: Bent portion

220: First connection frame

230: First spacing maintaining part

240: First length extension part

251: Stopper frame

252: Stopper plate

253: Stopper

300: Second base frame

310: Pair of second support frames

312: Locking protrusion

320: Second connection frame

330: Second spacing maintaining part

340: Second length extension part

400: Fixing frame

410: First link

420: Second link

500: Cradle frame

510: Pair of first cradle members

520: Second cradle member

530: Locking frame

What is claimed is:

1. A multipurpose stand for pets comprising:
a first base frame including a pair of first support frames disposed parallel to each other and a first connection frame connecting one end of the pair of first support frames;
a second base frame including a pair of second support frames disposed parallel to each other and rotatably coupled to the pair of first support frames, and a second connection frame connecting one end of the pair of second support frames;
a fixing frame connecting between the first support frame and the second support frame and supporting the first support frame and the second support frame to be disposed at a predetermined angle; and
a cradle frame rotatably coupled to the pair of first support frames, supporting a bottom surface of an object disposed on the first connection frame and the second connection frame, and having a supporting position that changes corresponding to the height of the object.

2. The multipurpose stand for pets according to claim 1, wherein the cradle frame comprises:
a pair of first cradle members rotatably coupled to the pair of first support frames;
a second cradle member connecting one end of the pair of first cradle members and bent in a direction perpendicular to the pair of first cradle members; and
a locking frame connecting the other end of the pair of first cradle members.

3. The multipurpose stand for pets according to claim 2, wherein the cradle frame is configured such that:
the pair of first cradle members rotate in a first direction so that the second cradle member is disposed horizontally and the second cradle member supports the bottom surface of a first object, and
the pair of first cradle members rotate in a second direction opposite to the first direction so that the pair of first cradle members are disposed horizontally and support the bottom surface of a second object having a height higher than the first object.

4. The multipurpose stand for pets according to claim 3, wherein the first base frame comprises:
a stopper frame connecting between the pair of first support frames;
a stopper plate coupled to the stopper frame; and
a stopper slidably coupled to the stopper plate and restraining the locking frame from rotating in the second direction when the second cradle member is in a horizontal state.

5. The multipurpose stand for pets according to claim 3, wherein the pair of first support frames include bent portions bent inward in a direction facing each other, and
when the pair of first cradle members are horizontal, the second cradle member is supported on the bent portions and restrained from further rotating in the second direction.

6. The multipurpose stand for pets according to claim 1, wherein the fixing frame comprises:
a first link rotatably coupled to the first support frame; and
a second link rotatably coupled to the second support frame and the first link.

7. The multipurpose stand for pets according to claim 1, comprising:
a pair of first length extension parts inserted into the other end of the pair of first support frames, respectively, to adjust length; and
a pair of second length extension parts inserted into the other end of the pair of second support frames, respectively, to adjust length.
